(19) United States
(12) Patent Application Publication
(10) Pub. No.: US 2009/0319522 A1
(43) Pub. Date: Dec. 24, 2009

(54) PROVIDING RELEVANT SPONSORED LINKS BASED ON USER INTERFACE DATA

(75) Inventor: Christopher K. Karstens, Apex, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/141,167

(22) Filed: Jun. 18, 2008

(51) Int. Cl. G06F 7/06; G06F 3/048

(52) U.S. Cl. 707/6; 715/856; 707/E17.108

(57) ABSTRACT

A method for providing sponsored advertising based on interaction of a user with a user interface, such as a web browser, can be provided. The method can include providing a plurality of search results based on parameters received from the user via an online search engine or an e-commerce web site. A search result may include a link to a web page. The method further includes detecting at least one search result displayed on a viewable area of the user interface. The method further includes matching the at least one search result with at least one sponsored ad, such as by matching the content of the at least one search result with the content of the at least one sponsored ad. The method further includes providing the at least one sponsored ad for display in the viewable area of the user interface.

### BACKGROUND OF THE INVENTION

1. Field of the Invention

The present invention relates to the field of advertising and more particularly to software that provides sponsored advertising with higher relevance to a web user's needs.

2. Description of the Related Art

The use of online search engines and e-commerce web sites has become ubiquitous in today's society. It is common for people to use online search engines as a primary method of locating companies, suppliers of goods and services, web sites, and other information. It is also common for individuals to use e-commerce web sites as a primary method of purchasing goods and services and garnering information about products.

Typically, a web surfer will enter a word or phrase into a search engine, which in turn performs a search and responds with a list of search results that include links to web pages containing, or relevant to, the word or phrase entered. Companies and other entities are eager to have links to their web sites appear higher on the list of search results. Online search engines determine which web sites to rank highly, or list high, in the search results, based on algorithms that use some parameters that are not directly controllable by the web site owner. Likewise, a web surfer can enter a word or phrase into an e-commerce web site, which in turn performs a search and responds with a list of products or services relevant to the word or phrase entered. Manufacturers desire to have their products appear higher on the list of search results. E-commerce web sites determine which products to rank highly, or list high, in the search results, based on algorithms that use some parameters that are not directly controllable by the product manufacturer.

For a fee, an online search engine or e-commerce web site may list a company's web site or a manufacturer's products in the sponsored advertising portion of search results, i.e., the sponsored links section. Thus, if an advertising fee is paid, a company can guarantee that its web site will be shown as a search result responsive to certain search terms being entered at the online search engine or the e-commerce web site. This is advantageous for advertisers since it ensures that their advertising is targeted to users that are interested in certain subjects or types of products.

The sponsored advertising portion of online search results, however, is often solely based on the search terms that are entered by the user into the online search engine or e-commerce web site. The search results, therefore, are based only on a single point of information, thereby limiting the depth and relevance of the search results. Additionally, this approach is error prone and disregards other points of information that provide indicators of a web user's needs.

Therefore, there is a need to overcome the deficiencies with the prior art and more particularly for a more efficient way to provide relevant sponsored advertising on online search engines and e-commerce web sites.

### BRIEF SUMMARY OF THE INVENTION

Embodiments of the present invention address deficiencies of the art in respect to advertising and provide a novel and non-obvious method and computer program product for providing sponsored advertising with improved relevance to a user's desires. In an embodiment of the invention, a method for providing sponsored advertising based on interaction of a user with a user interface, such as a web browser, can be provided. The method can include providing a plurality of search results based on parameters received from the user via an online search engine or an e-commerce web site. A search result may include a link to a web page. The method further includes detecting at least one search result displayed on a viewable area of the user interface. The method further includes matching the at least one search result with at least one sponsored ad, such as by matching the content of the at least one search result with the content of the at least one sponsored ad. The method further includes providing the at least one sponsored ad for display in the viewable area of the user interface.

In another embodiment of the invention, a computer program product comprising a computer usable medium embodying computer usable program code for providing sponsored advertising based on interaction of a user with a user interface is disclosed. The computer program product includes computer usable program code for providing a plurality of search results based on parameters received from the user and computer usable program code for detecting at least one search result displayed on a viewable area of the user interface. The computer program product further includes computer usable program code for matching the at least one search result with at least one sponsored ad and computer usable program code for providing the at least one sponsored ad for display in the viewable area of the user interface.

In another embodiment of the invention, a method for providing sponsored advertising based on interaction of a user with a user interface, such as a web browser, can be provided. The method can include providing a plurality of search results based on parameters received from the user via an online search engine or an e-commerce web site. A search result may include a link to a web page. The method further includes detecting placement of a cursor of the user over at least one search result in the user interface. The method further includes matching the at least one search result with at least one sponsored ad, such as by matching the content of the at least one search result with the content of the at least one sponsored ad. The method further includes providing the at least one sponsored ad for display in the viewable area of the user interface.

In another embodiment of the invention, a computer program product comprising a computer usable medium embodying computer usable program code for providing sponsored advertising based on interaction of a user with a user interface is disclosed. The computer program product includes computer usable program code for providing a plurality of search results based on parameters received from the user and computer usable program code for detecting placement of a cursor of the user over at least one search result in the user interface. The computer program product further includes computer usable program code for matching the at least one search result with at least one sponsored ad and computer usable program code for providing the at least one sponsored ad for display in the viewable area of the user interface.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram illustrating a network architecture of a system for providing sponsored advertising based on interaction of a user with a user interface, in accordance with one embodiment of the present invention;

FIG. 2 is an illustration of a user interface that provides sponsored advertising based on interaction of the user with the user interface, in accordance with one embodiment of the present invention; and

FIG. 3 is an illustration of the user interface of FIG. 2, providing sponsored advertising based on alternative interactions of the user with the user interface, in accordance with one embodiment of the present invention.

### DETAILED DESCRIPTION OF THE INVENTION

Embodiments of the present invention address deficiencies of the art in respect to advertising and provide a novel and non-obvious method and computer program product for providing sponsored advertising with improved relevance to a user's desires. In an embodiment of the invention, a method for providing sponsored advertising based on interaction of a user with a user interface, such as a web browser, can be provided. The method can include providing a plurality of search results based on parameters received from the user via an online search engine or an e-commerce web site. A search result may include a link to a web page. The method further includes detecting at least one search result displayed on a viewable area of the user interface. The method further includes matching the at least one search result with at least one sponsored ad, such as by matching the content of the at least one search result with the content of the at least one sponsored ad. The method further includes providing the at least one sponsored ad for display in the viewable area of the user interface.

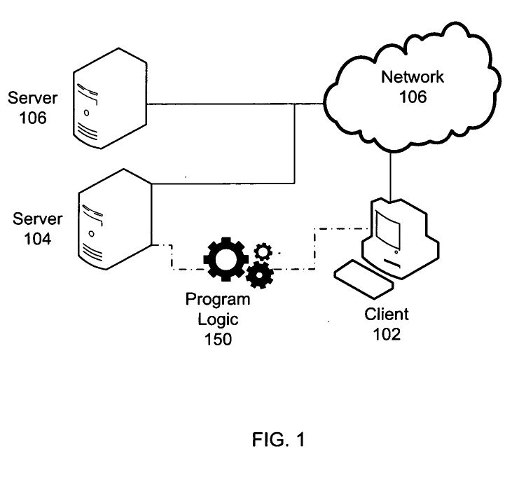

Referring now to the drawing figures in which like reference designators refer to like elements, there is shown in FIG. 1 a block diagram illustrating a network architecture of a system for providing sponsored advertising based on interaction of a user with a user interface, in accordance with one embodiment of the present invention. The exemplary embodiments of the present invention adhere to the system architecture of FIG. 1. FIG. 1 shows an embodiment of the present invention wherein a client user 102 may interact with servers 104-106 over a network 108, such as the Internet, the World Wide Web, a WAN or a LAN.

FIG. 1 shows client user 102 and servers 104-106 connected to network 108 via computers, such as desktop personal computers, workstations or servers. Servers 104, 106 include software engines that deliver data and/or user interface component functionality to client computer 102. The servers 104-106 may adhere to any commercially available server platform, such as the Sun Microsystems J2EE platform, a Web-based application platform, an integrated platform for e-commerce or a content management system platform. It should be noted that although FIG. 1 shows only one client user 102 and two servers 104-106, the system of the present invention supports any number of client users and servers connected via network 108.

FIG. 1 shows a system whereby a client application, represented by program logic 150, running on a client 102 automatically displays sponsored advertising based on interaction of the user with a user interface such as a web browser. The sponsored advertising displayed in the web browser may include information received from servers 104-106. Program logic 150 comprises computer source code, scripting language code or interpreted language code that is compiled to produce computer instructions that perform various functions of the present invention. In one embodiment of the present invention, the program logic 150 is a scripting language, such as ECMAScript, Cascading style sheets, XML, XSLT, Javascript, AJAX, XUL, JSP, PHP, and ASP, which runs in a web browser.

As explained above, program logic 150 may reside on a client 102, or a server (such as server 104) or any combination of the two. In one embodiment of the present invention, the program logic 150 is a client-server application having a client portion that resides on the computer of client user 102 and a server application that resides on a server, such as servers 104-106.

In an embodiment of the present invention, the computer systems of client user 102 and servers 104-106 are one or more Personal Computers (PCs), Personal Digital Assistants (PDAs), hand held computers, palm top computers, lap top computers, smart phones, game consoles or any other information processing devices. A PC can be one or more IBM or compatible PC workstations running a Microsoft Windows or LINUX operating system, one or more Macintosh computers running a Mac OS operating system, or an equivalent. In another embodiment, the computer systems of client user 102 and servers 104-106 are a server system, such as IBM RS/6000 workstations and servers running the AIX operating system.

In an embodiment of the present invention, the network 108 is a circuit switched network, such as the Public Service Telephone Network (PSTN). In another embodiment, the network 108 is a packet switched network. The packet switched network is a wide area network (WAN), such as the global Internet, a private WAN, a local area network (LAN), a telecommunications network or any combination of the above-mentioned networks. In yet another embodiment, the structure of the network 108 is a wired network, a wireless network, a broadcast network or a point-to-point network.

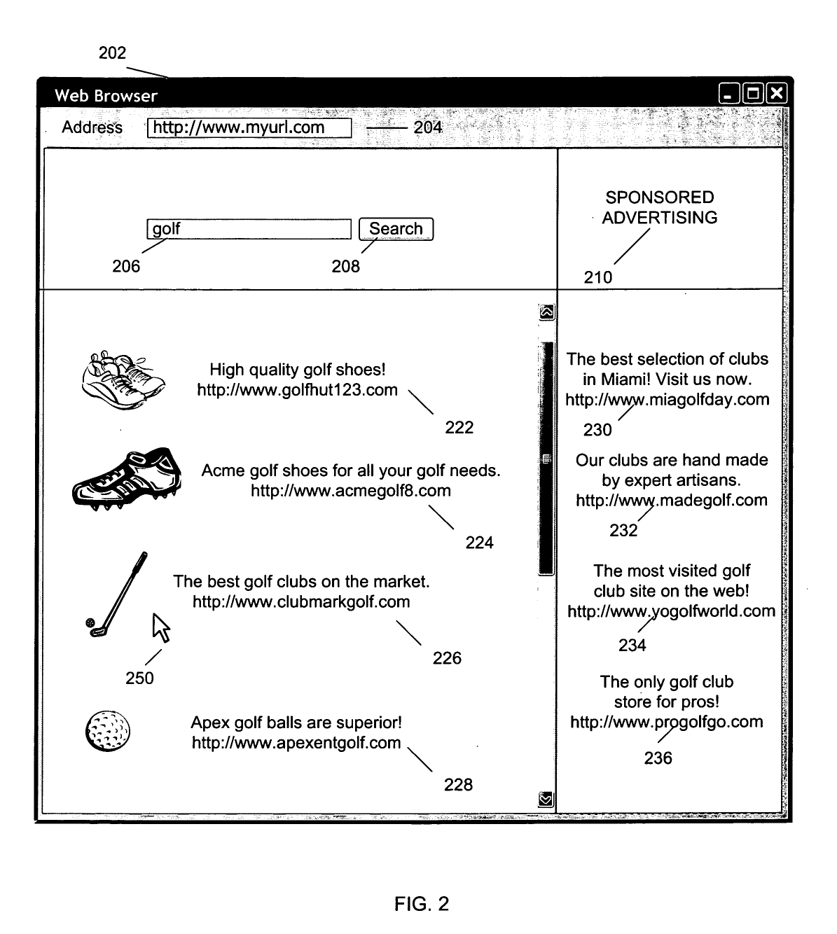

FIG. 2 is an illustration of a user interface 202 that provides sponsored advertising based on interaction of the user with the user interface 202, in accordance with one embodiment of the present invention. FIG. 2 shows that the user interface 202 is a conventional web browser. FIG. 2 shows that the web browser 202 includes an address text field 204 that indicates a Universal Resource Locator (URL) of a web site. Upon entering the appropriate URL, the web browser 202 sends a HyperText Transfer Protocol (HTTP) request for data to the appropriate web server, such as web server 104, corresponding to said URL. Subsequently, the web server 104 sends executable data to the web browser 202. The executable data received by the web browser 202 may be HTML or may comprise some or all of the program logic 150, which may be a scripting language such as XML, XSLT, Javascript, etc. Upon receiving the executable data sent by web server 104, web browser 202 executes the executable data, which produces the graphics displayed in user interface 202, as shown in FIG. 2.

FIG. 2 shows that the user 102 has entered a search parameter, comprising the word “golf,” into the text field 206 and pressed the accompanying button 208, which initiates a search by an online search engine or an e-commerce web site identified by the URL in text field 204. The results of the search are presented below text field 206 as search results 222, 224, 226 and 228. Each search result may comprise a picture or graphic of a product or service, a portion of text that may briefly describe the product or service and a hyperlink including a URL to a web site that sells the product or service.

Alternative to the initiation of a search by an online search engine, the user may make selections on an e-commerce web site, such as navigating through a catalog of products, selecting features desired in a product or making selections in a consumer buying guide. Based on the selections of the user, the e-commerce web site identified by the URL in text field 204 searches for corresponding products or services. The results of the search are presented below text field 206 as search results 222, 224, 226 and 228.

Note that the search results 222, 224, 226 and 228, garnered in response to the ambiguous search term “golf,” returns a set of search results that provide a wide range of golf products. FIG. 2 shows that the mouse cursor 250 of the user is placed over search result 226 pertaining to a particular type or subset of product pertaining to the search term. Specifically, search result 226 pertains to golf clubs. Program logic 150 detects the placement of the mouse cursor 250 and reads the content of search result 226. Various pieces of data may be read from search result 226, such as the picture or graphic, the portion of text that may briefly describe the product or service and the hyperlink including a URL. In one embodiment of the present invention, the program logic 150 searches for keywords in the data read from search result 226. In the current example, the program logic 150 garners the keywords “golf clubs” from the search result 226.

Program logic 150 subsequently accesses a data repository, such as a list, that pairs sponsored ads with keywords. Then, program logic 150 searches the list for the keywords garnered from search result 226 (namely, keywords “golf clubs”). Program logic 150 then selects the sponsored ads in the list that match the keywords that were garnered from search result 226. The sponsored ads 230, 232, 234, 236 that were selected are subsequently displayed in the “Sponsored Advertising” section 210 of the web browser 202. Note that sponsored ads 230, 232, 234, 236 are all relevant or pertain to the keywords garnered from search result 226, namely, keywords “golf clubs.” Each sponsored may comprise a picture or graphic of a product or service, a portion of text that may briefly describe the product or service and a hyperlink including a URL to a web site that sells the product or service.

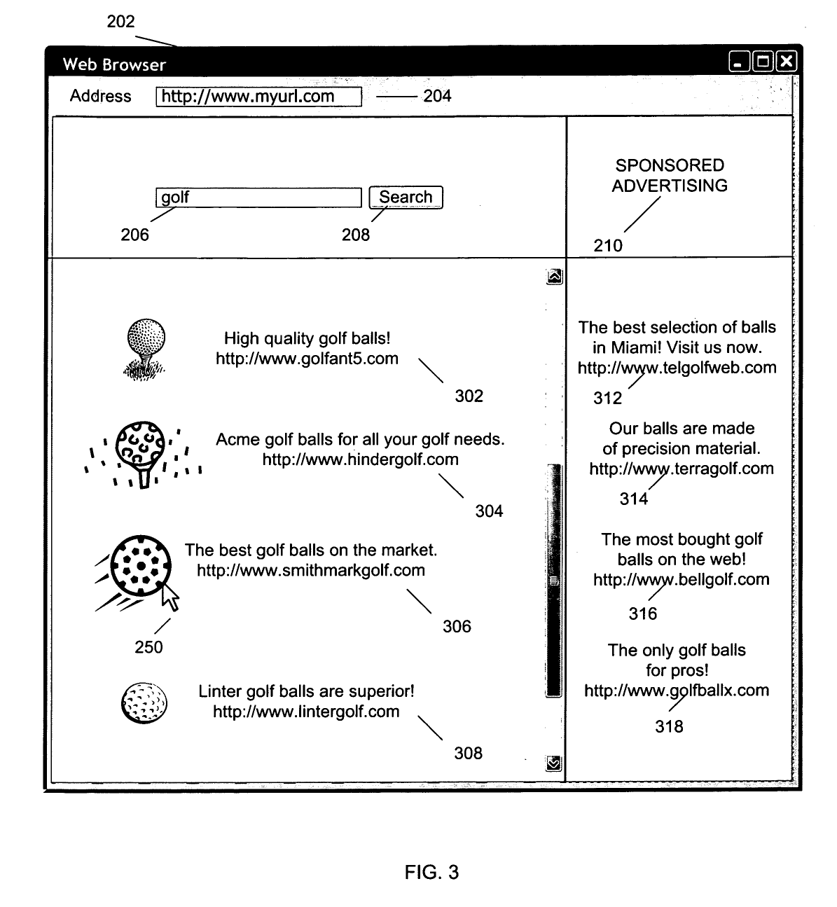

FIG. 3 is an illustration of the user interface 202 of FIG. 2, providing sponsored advertising based on alternative interactions of the user with the user interface 202, in accordance with one embodiment of the present invention.

Like FIG. 2, the results of a search using the “golf” search parameter are presented below text field 206 as search results 302, 304, 306 and 308. Note, however, that the user has scrolled down the list of search results such that the search results shown in FIG. 3 are different from the search results shown in FIG. 2. More specifically, the search results 302, 304, 306 and 308 shown in FIG. 3 all pertain to a certain type of product, namely, golf balls.

Program logic 150 detects the display of search results 302, 304, 306 and 308 in the viewable area of the web browser 202 reads the content of search results 302, 304, 306 and 308. The viewable area of a web browser is that portion of the data in a web browser that is currently being displayed and is viewable by a user. When a web browser is provided with more data than it can display, a scroll bar is usually provided so that only a portion of the data is displayed in the viewable area of the web browser and the rest of the data is not viewed. As the user scrolls up or down, the data that was previously displayed exits the viewable area and new data is displayed in the viewable area of the web browser.

Various pieces of data may be read from search results 302, 304, 306 and 308, such as the picture or graphic, the portion of text that may briefly describe the product or service and the hyperlink including a URL. In one embodiment of the present invention, the program logic 150 searches for keywords in the data read from search results 302, 304, 306 and 308. In the current example, the program logic 150 garners the keywords “golf balls” from the search results 302, 304, 306 and 308.

Program logic 150 subsequently accesses the data repository or list that pairs sponsored ads with keywords. Then, program logic 150 searches the list for the keywords garnered from search results 302, 304, 306 and 308 (namely, keywords “golf balls”). Program logic 150 then selects the sponsored ads in the list that match the keywords that were garnered from search results 302, 304, 306 and 308. The sponsored ads 312, 314, 316 and 318 that were selected are subsequently displayed in the “Sponsored Advertising” section 210 of the web browser 202. Note that sponsored ads 312, 314, 316 and 318 are all relevant or pertain to the keywords garnered from search results 302, 304, 306 and 308, namely, keywords “golf balls.”

The present invention is advantageous because it provides relevant sponsored advertising based on more than a single point of information, namely, user interactions with the user interface, such as the location of the mouse cursor and the content of the search results in the viewable area of the user interface. Thus, the present invention increases the depth and relevance of the search results displayed to the user. Additionally, the present invention utilizes points of information that provide supplementary indicators of a web user's needs, thereby increasing the ability to provide relevant sponsored ads to the user.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

I claim:

1. A method for providing sponsored advertising based on interaction of a user with a user interface, comprising:
providing a plurality of search results based on parameters received from the user;
detecting at least one search result displayed on a viewable area of the user interface;
matching the at least one search result with at least one sponsored ad; and
providing the at least one sponsored ad for display in the viewable area of the user interface.

2. The method of claim 1, wherein the step of providing a plurality of search results comprises:
providing a plurality of search results based on search parameters received from the user via the user interface.

3. The method of claim 1, wherein the step of providing a plurality of search results comprises:
providing a plurality of search results based on selections made by the user via the user interface.

4. The method of claim 1, wherein the step of detecting comprises:
detecting at least one search result displayed on a viewable area of the user interface and reading content of the at least one search result.

5. The method of claim 4, wherein the step of matching comprises:
matching content of the at least one search result with content of at least one sponsored ad.

6. A computer program product comprising a computer usable medium embodying computer usable program code for providing sponsored advertising based on interaction of a user with a user interface, the computer program product comprising:
computer usable program code for providing a plurality of search results based on parameters received from the user;
computer usable program code for detecting at least one search result displayed on a viewable area of the user interface;
computer usable program code for matching the at least one search result with at least one sponsored ad; and
computer usable program code for providing the at least one sponsored ad for display in the viewable area of the user interface.

7. The computer program product of claim 6, wherein the computer usable program code for providing a plurality of search results comprises:
computer usable program code for providing a plurality of search results based on search parameters received from the user via the user interface.

8. The computer program product of claim 6, wherein the computer usable program code for providing a plurality of search results comprises:
computer usable program code for providing a plurality of search results based on selections made by the user via the user interface.

9. The computer program product of claim 6, wherein the computer usable program code for detecting comprises:
computer usable program code for detecting at least one search result displayed on a viewable area of the user interface and reading content of the at least one search result.

10. The computer program product of claim 9, wherein the computer usable program code for matching comprises:
computer usable program code for matching content of the at least one search result with content of at least one sponsored ad.

11. A method for providing sponsored advertising based on interaction of a user with a user interface, comprising:
providing a plurality of search results based on parameters received from the user;
detecting at least one search result displayed on a viewable area of the user interface;
detecting placement of a cursor of the user over at least one search result in the user interface;
matching the at least one search result with at least one sponsored ad; and
providing the at least one sponsored ad for display in the viewable area of the user interface.

12. The method of claim 11, wherein the step of providing a plurality of search results comprises:
providing a plurality of search results based on search parameters received from the user via the user interface.

13. The method of claim 11, wherein the step of providing a plurality of search results comprises:
providing a plurality of search results based on selections made by the user via the user interface.

14. The method of claim 11, wherein the step of detecting comprises:
detecting placement of a cursor of the user over at least one search result in the user interface and reading content of the at least one search result.

15. The method of claim 14, wherein the step of matching comprises:
matching content of the at least one search result with content of at least one sponsored ad.

16. A computer program product comprising a computer usable medium embodying computer usable program code for providing sponsored advertising based on interaction of a user with a user interface, the computer program product comprising:
computer usable program code for providing a plurality of search results based on parameters received from the user;
computer usable program code for detecting placement of a cursor of the user over at least one search result in the user interface;
computer usable program code for matching the at least one search result with at least one sponsored ad; and
computer usable program code for providing the at least one sponsored ad for display in the viewable area of the user interface.

17. The computer program product of claim 16, wherein the computer usable program code for providing a plurality of search results comprises:
computer usable program code for providing a plurality of search results based on search parameters received from the user via the user interface.

18. The computer program product of claim 16, wherein the computer usable program code for providing a plurality of search results comprises:
computer usable program code for providing a plurality of search results based on selections made by the user via the user interface.

19. The computer program product of claim 16, wherein the computer usable program code for detecting comprises:
computer usable program code for detecting placement of a cursor of the user over at least one search result in the user interface and reading content of the at least one search result.

20. The computer program product of claim 19, wherein the computer usable program code for matching comprises:
computer usable program code for matching content of the at least one search result with content of at least one sponsored ad.
